(19) United States
(12) Patent Application Publication
(10) Pub. No.: US 2013/0290231 A1
(43) Pub. Date: Oct. 31, 2013

(54) PATIENT CONDITION DETECTION AND MORTALITY

(71) Applicant: Nicolas Wadih Chbat, White Plains, NY (US)

(72) Inventor: Nicolas Wadih Chbat, White Plains, NY (US)

(73) Assignee: Koninklijke Philips Electronics N.V., Eindhoven (NL)

(21) Appl. No.: 13/996,565

(22) PCT Filed: Dec. 12, 2011
(86) PCT No.: PCT/IB11/55610

§ 371 Date: Jun. 21, 2013

Related U.S. Application Data
(60) Provisional application No. 61/425,388, filed on Dec. 21, 2010.

(51) Int. Cl. G06F 19/00

(52) U.S. Cl. CPC G06F 19/345
USPC 706/21

(57) ABSTRACT

When prediction onset of a medical condition for a patient, multiple sources of knowledge (112) are aggregated and modeled into a format that is usable by multiple algorithms including an inference algorithm (134), a Bayesian network (136), and a state machine (138). The outputs (116) of the multiple algorithms are then combined to more accurately predict condition onset. For instance, several knowledge sources can be input to each of the inference algorithm, the Bayesian network, and the finite state machine, and the outputs of each algorithm are combined, optionally weighted, etc., to make a final determination of the likelihood that the patient has or will imminently have the specified medical condition.

The present application finds particular application in medical diagnostic systems, e.g. patient condition diagnosis. However, it will be appreciated that the described technique may also find application in other diagnostic systems, other patient modeling scenarios, or other diagnostic techniques.

Patient diagnosis is a complex matter that often requires the consideration of several information sources. With advances in computer processing speed and data storage, such information sources have become more readily-available to physicians, but knowing where to look for diagnostic assistance and how to apply medical information once it is located can be a computationally-complex task. Moreover, once a physician has access to relevant diagnostic information from multiple sources, the physician must weigh the different information sources to generate a reliable diagnosis, which further complicates the diagnosis procedure.

Conventional techniques for patient diagnosis often suffer from poor detection success rates and an inability to assess mortality rates. Typically, by the time some conditions are detected or diagnosed, it is too late to effectively treat the patient.

The present application provides new and improved systems and methods for detecting patient medical conditions, which overcome the above-referenced problems and others.

In accordance with one aspect, a system that facilitates predicting onset of a medical condition in a patient includes a plurality of medical information databases, and a processor that executes computer-executable instructions that are stored in a memory, the instructions comprising aggregating medical information input from the plurality of information database, and inputting aggregated medical information into each of an inference algorithm, a Bayesian network, and a finite state machine. The instructions further comprise executing each of the inference algorithm, the Bayesian network, and the finite state machine, and aggregating output information from each of the inference algorithm, the Bayesian network, and the finite state machine. The instructions further comprise determining whether a patient has the medical condition based at least in part on the aggregated output information, and controlling a display to display the determination of whether the patient has the medical condition to a user on a display.

In accordance with another aspect, a method of predicting onset of a medical condition in a patient includes aggregating medical information input from a plurality of information databases, inputting aggregated medical information into each of an inference algorithm, a Bayesian network, and a finite state machine, and executing each of the inference algorithm, the Bayesian network, and the finite state machine. The method further includes aggregating output information from each of the inference algorithm, the Bayesian network, and the finite state machine, determining whether a patient has the medical condition based at least in part on the aggregated output information, and controlling a display to display the determination of whether the patient has the medical condition to a user on a display.

In accordance with another aspect, a method of predicting whether a patient has a specified medical condition includes aggregating a plurality of medical knowledge sources, inputting clinical knowledge-based rules, pre-intensive care unit (pre-ICU) information, and ICU data into an inference algorithm, inputting clinical research-based probability information, pre-ICU information, and ICU data into a Bayesian network, and inputting clinical definition-based logic flows, pre-ICU information, and ICU data into a state machine. The method further includes aggregating output information from each of the inference algorithm, the Bayesian network, and the state machine to determine whether the patient has the specified medical condition, and outputting the determination of whether the patient has the specified condition to a user.

One advantage is that patient condition detection is improved.

Another advantage resides in reducing patient mortality rates.

Still further advantages of the subject innovation will be appreciated by those of ordinary skill in the art upon reading and understanding the following detailed description.

The innovation may take form in various components and arrangements of components, and in various steps and arrangements of steps. The drawings are only for purposes of illustrating various aspects and are not to be construed as limiting the invention.

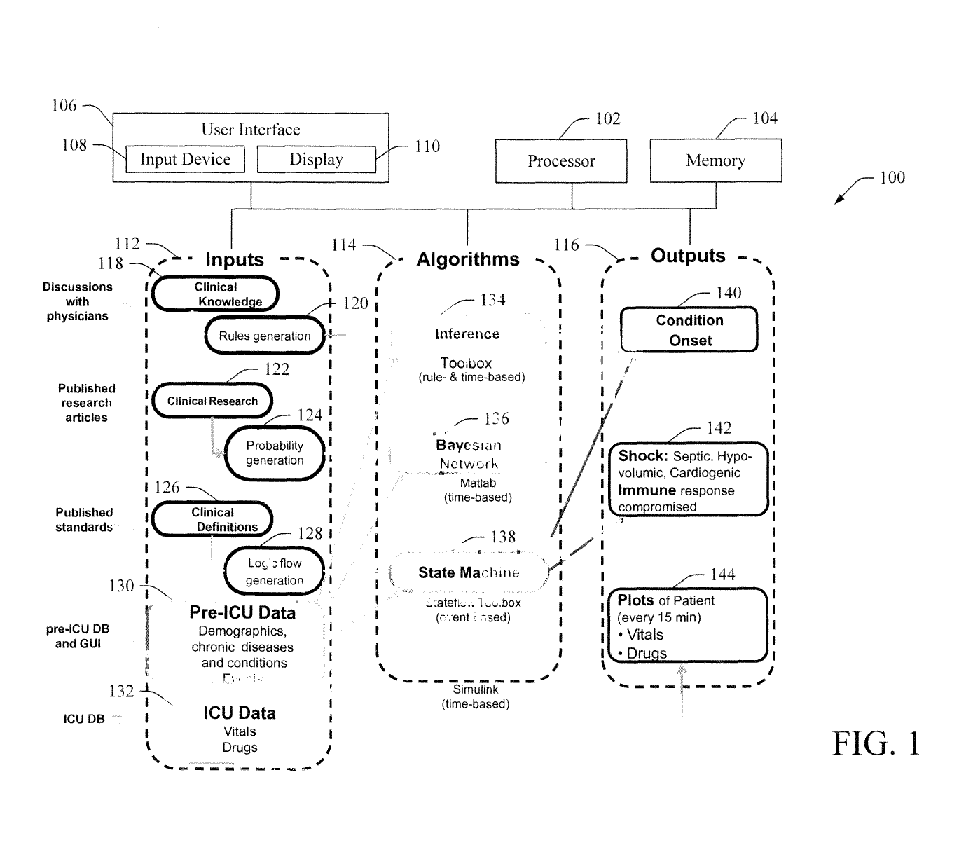

FIG. 1 illustrates a system for detecting medical problems in a patient.

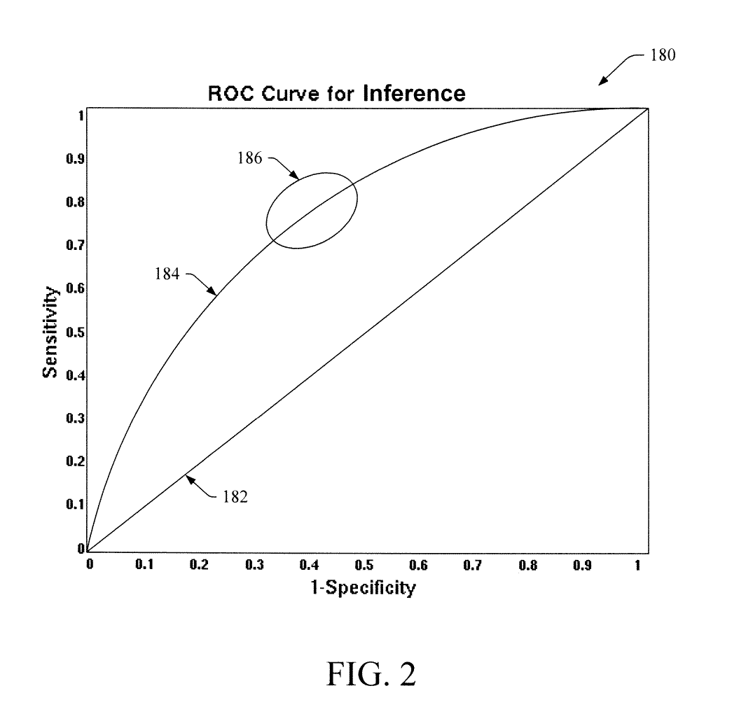

FIG. 2 illustrates a receiver-operator curve (ROC) showing condition onset for a specified condition as determined by the inference algorithm.

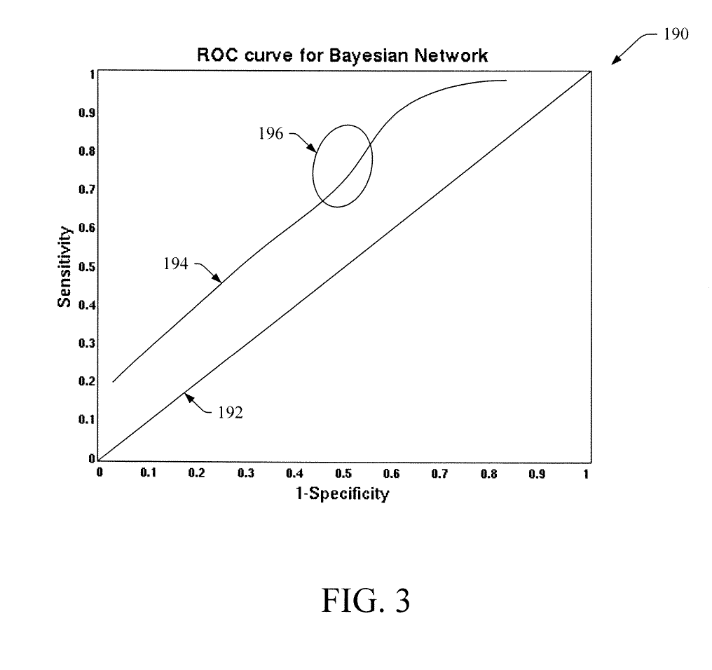

FIG. 3 illustrates a receiver-operator curve (ROC) showing condition onset for a specified condition as determined by the Bayesian network.

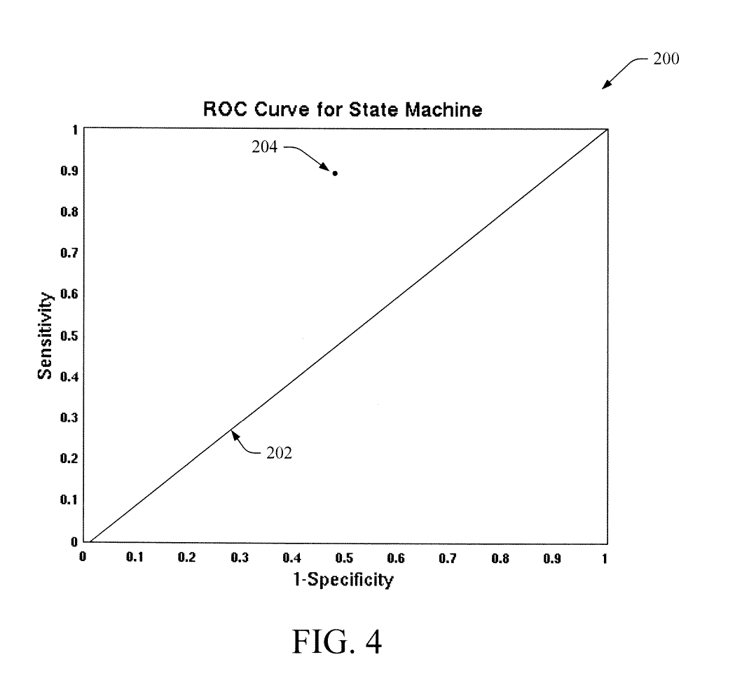

FIG. 4 illustrates a receiver-operator curve (ROC) showing condition onset for a specified condition as determined by the state machine.

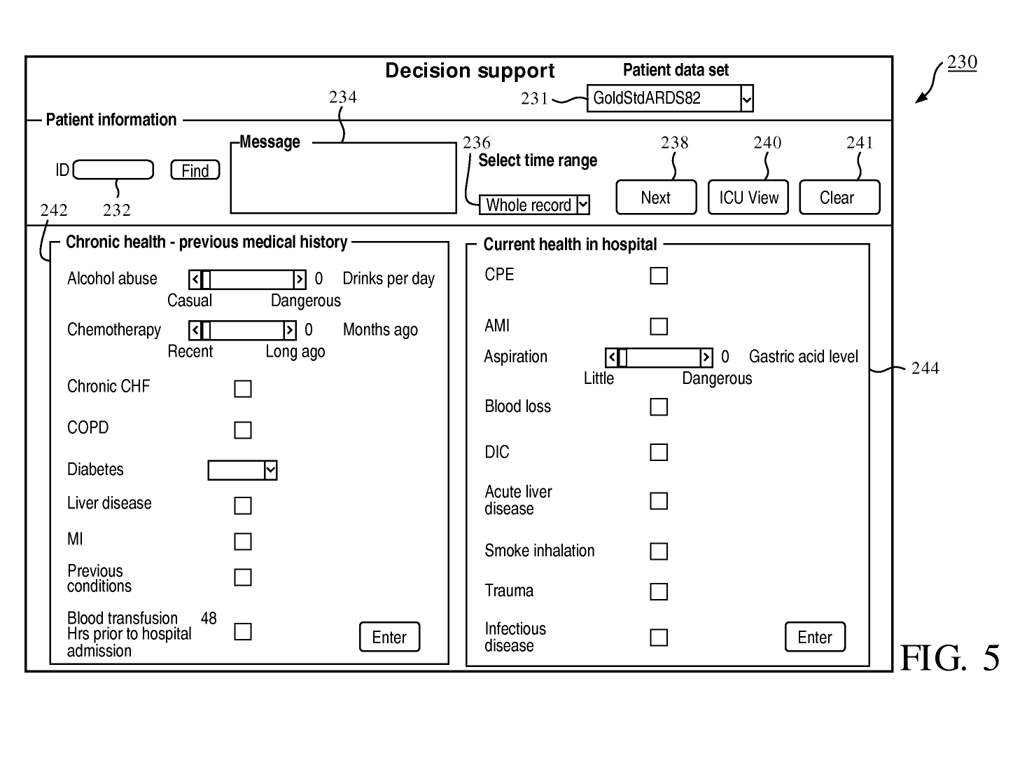

FIG. 5 illustrates a GUI, which is presented to a user on a computer display.

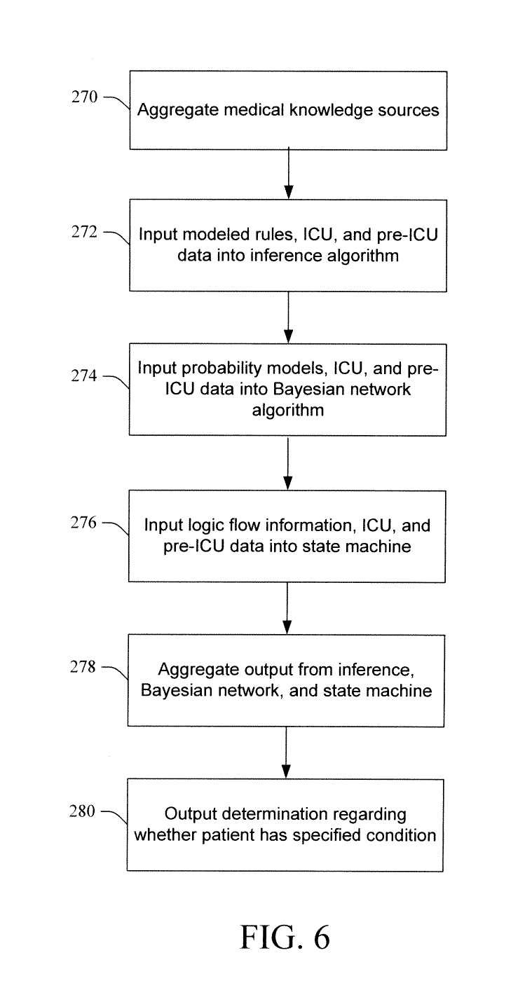

FIG. 6 illustrates a method of aggregating medical information sources as input for a plurality of modeling algorithms, executing the algorithms, and combining the algorithm outputs to determine whether a patient has or will imminently have a specified medical condition.

The subject innovation overcomes the problem of poor detection rates by combining multiple sources of knowledge, modeling the knowledge sources into a format that is usable by multiple algorithms, and combining the output of the multiple algorithms to more accurately predict condition onset. For instance, several knowledge sources can be input to each of an inference algorithm, a Bayesian network, and a finite state machine, and the outputs of each algorithm can be combined, optionally weighted, etc., to make a final determination of the likelihood that the patient has or will imminently have a specified condition.

FIG. 1 illustrates a system 100 for detecting medical problems in a patient. The system includes a processor 102 that executes, and a memory 104 that stores, computer-executable instructions (e.g., algorithms, routines, executables, programs, etc.) for carrying out the various protocols, procedures, methods, functions, modules, etc., described herein. The processor 102 and memory 104 are coupled to a user interface 106 that includes an input device into which a user enters information and a display 108 on which information is output or displayed to the user. A plurality of inputs 112 are input into the memory (e.g., via the user interface or downloaded locally or remotely from one or more databases). The inputs 112 are analyzed and/or manipulated by a plurality of algorithms 114 executed and/or maintained by the processor 102 to generate a plurality of outputs 116 that are presented to a user on the display 110.

The inputs include three initial sources of knowledge: a clinical knowledge database 118 from which rules are generated by a rules generation module; a clinical research database 122 from which probabilities are generated by a probability generation module 124; and a clinical definitions database 126 that includes published standards from which a logic flow is generated by a logical flow generation module 128. As used herein, a “module” is a set of computer-executable instructions that are stored on a computer-readable medium, such as the memory 104 for execution by the processor 102 or other means for performing the described function. The rules generated by the rules generation module 120 are used by the processor 102 to configure an inference algorithm 134. The probabilities generated by the probability generation module 124 are used by the processor 102 to configure a Bayesian network 136. The logic flow generated by the logic flow generation module 128 is used by the processor 102 to configure a state machine 138. For each patient, pre-ICU from a pre-ICU database 130 and ICU data from an ICU database 132 are also considered as inputs 112 to the algorithms 114. Pre-ICU data may include without limitation data related to patient demographics, chronic diseases and conditions, and events data. ICU data may include without limitation vital signs and medicines. The pre-ICU data and ICU data are also fed into all three algorithms 134, 136, 138.

The outputs of the inference algorithm 134, the Bayesian network 136, and the state machine 138 are subject to a threshold comparison that indicates whether the patient has or will imminently have a specified condition, or the probability that the patient has such a condition. For instance, based on the output of the three algorithms 114, an onset condition probability (e.g., 60% likelihood, 90% likelihood, etc.,) may be presented to the user as an onset output 140. In another example, the onset output 140 is a “yes” or “no,” which is determined as a result of the comparison of a probability determined from the three algorithms 114 to a predetermined threshold (e.g., if the algorithms 114 indicate a greater than 50% change that the patient has the specified condition, then the onset output 140 is a “yes,” and otherwise it is a “no.”

Additionally, the outputs of the state machine 138 include shock and immune system information 142 (e.g., septic shock, hypovolemic shock, cardiogenic shock, whether the immune system has been compromised, etc.). ICU data 132 may also be output directly by the processor 102 as one or more plots or graphs 144 (e.g., vital signs, drug or medicinal dose information, etc.)

In this manner, five main knowledge sources of a condition (e.g., hyperglycemia) facilitate the development and execution of three algorithms 114. For example, using the system of FIG. 1, the condition is detected independently by each of the inference algorithm 134, the Bayesian network 136, and the finite state machine 138. In one embodiment, ultimate condition onset determination is performed based on 2 out of 3 algorithms detecting the condition. Additionally, the different algorithms complement each other in that they account for and use different types of information. For instance, the interface algorithm 134 deals with imprecise and/or subjective values (e.g., warm or cool, large or small, etc.), while the Bayesian network deals with discrete values, such as heart rate, respiratory rate, etc. The state machine accounts for logical if-then flows or information, and outputs a status (e.g., yes or no).

As stated above, the system 100 includes the processor 102 that executes, and the memory 104, which stores, computer-executable instructions (e.g., routines, programs, algorithms, software code, etc.) for performing the various functions, methods, procedures, etc., described herein. Additionally, “module,” as used herein, denotes a set of computer-executable instructions, software code, program, routine, or other means for performing the described function, or the like, as will be understood by those of skill in the art.

The memory may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

In another embodiment, the system 100 of FIG. 1 is used to generate mortality studies on virtual populations of patients, e.g., past patient records. For instance a number of virtual patients may be generated and input into the system (e.g., using the GUI 230 of FIG. 7), and mortality studies can be generated as a function of specific criteria common to a sub-population in the virtual patient population. In this manner, variables that contribute to condition onset are isolated.

FIG. 2 illustrates a receiver-operator curve (ROC) 180 showing condition onset for a specified condition as determined by the inference algorithm 134 (FIG. 1). In the ROC 180, plotted points form a curve 184 above and left of the line 182 indicate a likelihood or high probability (i.e., greater than 50%) that the patient has or will imminently have the specified condition. A region 186 of the curve 184 includes data points that can be selected as characteristic points for evaluation (e.g., having a relatively high sensitivity value and a relatively low specificity value.

FIG. 3 illustrates a receiver-operator curve (ROC) 190 showing condition onset for a specified condition as determined by the Bayesian network 136 (FIG. 1). In the ROC 190, plotted points form a curve 194 above and left of the line 192 indicate a likelihood or high probability (i.e., greater than 50%) that the patient has or will imminently have the specified condition. A region 196 of the curve 194 includes data points that can be selected as characteristic points for evaluation (e.g., having a relatively high sensitivity value and a relatively low specificity value.

FIG. 4 illustrates a receiver-operator curve (ROC) 200 showing condition onset for a specified condition as determined by the state machine 138 (FIG. 1). In the ROC 200, the plot point 204 above and left of the line 202 indicates a likelihood or high probability (i.e., greater than 50%) that the patient has or will imminently have the specified condition. The state machine thus outputs a single yes or no describing the state of the patient based on the input information received.

FIG. 5 illustrates a GUI 230, which is presented to a user on a computer display, such as the display 110 of FIG. 1. In one embodiment, the GUI 230 is used in, or in place of, the user interface 106 of FIG. 1. The GUI 230 facilitates entering chronic patient information and for running what-if scenarios, similar to those used in order to generate the virtual populations described with regard to FIGS. 5 and 6. The GUI 230 includes a patient data set field 231 allows a user to select a data set for review. The GUI also includes a patient information field 232 into which a user enters patient ID information (e.g., number, name, etc.), and message field 234 into which a user enters a message or via which a message is presented to the user. A time range field 236 permits a user to select a time range for which patient records are returned for review. A “next” button or icon 238 permits a user to navigate to a subsequent GUI page, when selected. An “ICU” button or icon 240 permits the user to navigate to an ICU page, when selected. A “clear” button or icon 241 permits a user to clear all fields in the GUI 230, when selected.

A “chronic health” field 242 comprises a plurality of fields and boxes that may be selected to indicate patient conditions. Additionally, a “current health” field 244 includes a plurality of fields and boxes that may be selected by the user to enter current patient health information.

FIG. 6 illustrates a method related to aggregating medical information from a plurality of sources, inputting the aggregated information into a multi-algorithm model, and determining that a patient has a specified condition based on the model output. While FIG. 8 relates to a series of acts, it will be understood that not all acts may be required to achieve the described goals and/or outcomes, and that some acts may, in accordance with certain aspects, be performed in an order different that the specific orders described.

At 270, medical knowledge sources are aggregated for inputting into a plurality of algorithms or modules. For instance, clinical knowledge collected from discussions with physicians, experts, or the like, is modeled into a plurality of rules. Clinical research information is manipulated to generate probability tables that correlate patient symptoms and/or signs to a probability that the patient has a given condition. Clinical definition information (e.g., published standards, etc.) are modeled into logical flows that describe patient condition(s). Additionally, ICU and pre-ICU information is prepared as input to the plurality of algorithms or modules.

At 272, the modeled rules, pre-ICU data (e.g., patient demographics, chronic diseases, conditions, events, etc.), and ICU data (e.g., vital sign data, drug administration data, etc.) are input to the inference algorithm 134 to determine whether the patient has the specified condition. At 274, the probability information, pre-ICU data (e.g., patient demographics, chronic diseases, conditions, events, etc.), and ICU data (e.g., vital sign data, drug administration data, etc.) are input to the Bayesian network 136 to determine whether the patient has the specified condition. At 276, the logical flow information, pre-ICU data (e.g., patient demographics, chronic diseases, conditions, events, etc.), and ICU data (e.g., vital sign data, drug administration data, etc.) are input to the finite state machine 138 to determine whether the patient has the specified condition.

At 278, output results from the inference algorithm, the Bayesian network, and the state machine are aggregated. At 280, a determination is made as to whether the patient has or imminently will have the specified condition, based on the aggregate output from all three of the algorithms.

In one embodiment, the output information is used to generate a virtual patient population that is used to generate mortality rates due to one or more variables associate with the specified medical condition.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A system that facilitates predicting onset of a medical condition in a patient, including:
a plurality of medical information databases; and
a processor that executes computer-executable instructions that are stored in a memory, the instructions comprising:
aggregating medical information input from the plurality of information databases;
inputting aggregated medical information into each of an inference algorithm, a Bayesian network, and a finite state machine;
executing each of the inference algorithm, the Bayesian network, and the finite state machine;
aggregating output information from each of the inference algorithm, the Bayesian network, and the finite state machine; and
determining whether a patient has the medical condition based at least in part on the aggregated output information; and
controlling a display to display the determination of whether the patient has the medical condition to a user on a display.

2. The system according to claim 1, further including:
a rules generation module that generates rules based on clinical knowledge in the clinical knowledge database for input into the inference algorithm,
a probability generation module that generates probabilities based on clinical research information in a clinical research database for input into the Bayesian network; and
a logic flow generation module that generates logic flows from clinical definitions in a clinical definition database for input into the state machine.

3. (canceled)

4. (canceled)

5. The system according to claim 1, wherein the inference algorithm receives as input:
clinical knowledge-based rules from the rules generation module;
pre-intensive care unit (pre-ICU) information; and
ICU data.

6. The system according to claim 1, wherein the Bayesian network receives as input:
clinical research-based probability information from the probability generation module;
pre-intensive care unit (pre-ICU) information; and
ICU data.

7. The system according to claim 1, wherein the state machine receives as input:
clinical definition-based logical flow information from the logic flow generation module;
pre-intensive care unit (pre-ICU) information; and
ICU data.

8. The system according to claim 1, wherein the pre-ICU data includes one or more of patient demographic information, patient chronic condition information, and patient event history information, and wherein the ICU data includes one or more of patient vital sign information and patient drug administration history information.

9. The system according to claim 1, wherein the output information includes one or more of:
condition onset information that is generated from output information from each of the inference algorithm, the Bayesian network, and the state machine;
shock and immune response information that is generated from the output of the state machine;
graphical patient information that is generated from the ICU data.

10. A method of predicting onset of a medical condition in a patient, including:
aggregating medical information input from a plurality of information databases;
inputting aggregated medical information into each of an inference algorithm, a Bayesian network, and a finite state machine;
executing each of the inference algorithm, the Bayesian network, and the finite state machine;
aggregating output information from each of the inference algorithm, the Bayesian network, and the finite state machine;
determining whether a patient has the medical condition based at least in part on the aggregated output information; and
controlling a display to display the determination of whether the patient has the medical condition to a user on a display.

11. The method according to claim 10, further including generating rules based on clinical knowledge in a clinical knowledge database for input into the inference algorithm;
generating probabilities based on clinical research information in a clinical research database for input into the Bayesian network; and
generating logic flows from clinical definitions in a clinical definition database for input into the state machine.

12. (canceled)

13. (canceled)

14. The method according claim 8, further including:
receiving as input at the inference algorithm:
clinical knowledge-based rules from the rules generation module;
pre-intensive care unit (pre-ICU) information; and
ICU data;
receiving as input at the Bayesian network:
clinical research-based probability information from the probability generation module;
pre-intensive care unit (pre-ICU) information; and
ICU data; and
receiving as input at the state machine:
clinical definition-based logical flow information from the logic flow generation module;
pre-intensive care unit (pre-ICU) information; and
ICU data.

15. The method according to claim 14, wherein the pre-ICU data includes one or more of patient demographic information, patient chronic condition information, and patient event history information, and wherein the ICU data includes one or more of patient vital sign information and patient drug administration history information.

16. The method according to claim 10, wherein the output information includes one or more of:
condition onset information that is generated from output information from each of the inference algorithm, the Bayesian network, and the state machine;
shock and immune response information that is generated from the output of the state machine;
graphical patient information that is generated from the ICU data.

17. A processor or computer-readable medium carrying a computer program that controls one or more processors to perform the method of claim 10.

18. A method of predicting whether a patient has a specified medical condition, including:
aggregating a plurality of medical knowledge sources;
inputting clinical knowledge-based rules, pre-intensive care unit (pre-ICU) information, and ICU data into an inference algorithm;
inputting clinical research-based probability information, pre-ICU information, and ICU data into a Bayesian network;
inputting clinical definition-based logic flows, pre-ICU information, and ICU data into a state machine;
aggregating output information from each of the inference algorithm, the Bayesian network and the state machine to determine whether the patient has the specified medical condition; and
outputting the determination of whether the patient has the specified condition to a user.

19. The method according to claim 18, further comprising:
generating a virtual patient population from the knowledge-based rules, the research-based probability information, and the logic flows, and determining mortality rates for the virtual population as a function of one or more variables associated with the specified medical condition.
